(19) United States
(12) Patent Application Publication
(10) Pub. No.: US 2009/0091849 A1
(43) Pub. Date: Apr. 9, 2009

(54) Pendant

(76) Inventor: Dollie L. King, Alexandria, VA (US)

Correspondence Address: DAVID J. WILSON, 61 BELCHER CIRCLE, MILTON, MA, 02186, US

(21) Appl. No.: 11/973,592

(22) Filed: Oct. 9, 2007

(51) Int. Cl. G02B 27/02

(52) U.S. Cl. 359/804

(57) ABSTRACT

The present invention relates to a pendant that permits the easy reading of text messages or visualization of images by providing a means for magnifying the text or images. In another aspect, the invention relates to a pendant that is designed to allow the easy exchange of the message or image contained in the pendant.

### BACKGROUND OF INVENTION

The field of the invention relates to pendants and other types of decorations that hang from or are part of jewelry. Pendants are well known in the art and are types of hanging ornaments used in jewelry applications. Many fanciful shapes and types have been produced for pendants through the years. Still, most pendants are designed only to have a pleasing look about them and are not usually designed to teach or convey messages. This is because the size of the pendant is usually not adequate for such purposes. Additionally, prior art pendants, once made, cannot be altered easily to convey a different message or teaching. Therefore, what is needed is a pendant that is designed to teach or convey messages effectively in spite of the limited space available on the pendant, permit the exchange of the message with a new message as well as being attractive to look at.

### SUMMARY OF INVENTION

In one aspect, the invention relates to a pendant that permits the easy reading of text messages or visualization of images. In another aspect, the invention relates to a pendant that is suitable for exchanging the message or image contained in the pendant easily.

In this regard, in one embodiment, the present invention contemplates a pendant comprising a translucent or clear material. In another embodiment, the front panel or frontispiece of the pendant is clear or translucent while parts or all of the remainder of the pendant may be opaque. In another embodiment, the front panel of the pendent is clear or translucent and the rear panel has an image or picture printed on it that is visible through the front panel. Thus, the pendant or main unit of the pendant comprises, for example, plastic or glass. The present invention is not limited to any particular type of plastic or glass providing that the plastic or glass is not easily scratched during normal use. Non-limiting examples of suitable types of plastic are Lucite™ and acrylic (also known as polymethyl methacrylate (PMMA) or poly (methyl 2-methylpropenoate)), polycarbonate (preferred plastic for its scratch resistance), and polyvinyl chloride (PVC). Those practiced in the art will be able to identify other plastics suitable for use in the present invention based on the teachings contained herein. Any type of glass is suitable for use with the present invention.

The pendant of the present invention has two novel features not found in prior art pendants. First, the pendant comprises a slot in the top of the pendant suitable for inserting into the pendant sheet material (such as paper or plastic) imprinted with words and/or images. These words and/or images would be visible through the clear or translucent front panel. Also, the sheet material could be exchanged for other sheets at the users discretion. In other words, the sheet material is interchangeable with other sheets having other messages and/or images. As a non-limiting example, the user may insert a sheet material with a prayer on it. The text on the sheet material would then look as though it is suspended in the air within the pendent. In a preferred embodiment, the back of the pendent would have an image or picture permanently attached or printed on it. The picture or image would be visible through the front of the pendent since, for example, the text on the sheet material would be printed on a clear piece of sheet material. In this manner the viewer sees, through the front panel, the text as though it is suspended above the image or picture (or gives the viewer the impression that the text is suspended in air above the image or picture). The present invention is not limited by the nature of the text, words or the image or picture used. In a preferred embodiment, the text or words are a prayer or Bible phrases and the image is an religiously based picture such as, for example, praying hands, footprints, raised hands, a praying figure or a leafless tree. The present invention is in no way limited by the text or words or images used. For example, in another embodiment, the pendent could have an image of a logo (e.g., a company logo) and the sheet material could have motivational words. Logos of sports teams or scenery could also be used for the image.

In another embodiment, the pendent has the words and image imprinted on the sheet material so that both may be exchanged as desired. See, for example, FIGS. 3 and 4.

The pendant, in another embodiment, has a cover or door to seal or close the slot so that the sheet material will not fall out inadvertently. The cover or door may comprises a hinge and a latch or may be a press fit.

Second, the front panel of the pendent is designed to magnify the sheet material thereby making the words and/or images for a person viewing the pendant easier to see. The present invention is not limited by the amount of magnification so long as the words and/or image appears larger than it really is and is easier to read or see. In a preferred embodiment, the words on the sheet material and images on the rear panel are magnified at least 1.5 times (1.5×) but not more than 12 times (12×). The sheet material may be magnified by, for example, shaping the front (outward facing) side front panel of the pendant so that it is convex. It is known in the art that clear or translucent convex materials, when suitably curved, are effective in magnifying what is underneath them. Additionally, the front panel may have a convex shape on the rear side of the front panel (i.e., the inward side or the side of the front panel that would be closest to or touching the sheet material) thus being shaped like a magnifying lens or reading glass lens. The sheet material may also be magnified by, for example, attaching to the front of the pendant a magnifying device. The magnifying device may be, for example, a lens from a magnifying glass, or similar, shaped to fit the front panel. The construction of magnifying devices and lenses was known in the respective art at the time of this invention and it would be within the skill of those persons to make a suitable magnifying device or magnifying means for the present invention.

In another embodiment, the pendant may also have a clear or translucent back that also comprises a magnifying means. In this way, the pendant could contain two messages and/or images or have the same message and/or image on both the front and back thereby ensuring that a viewer would see the sheet material even if the pendant was turned over.

In another embodiment, the pendent of the present invention may also comprise a frame for holding the clear or translucent pendant. The frame may be made of any suitable material but preferred materials are one or more of metal, plastic or wood. The frame may also comprises moldings or printings for decorative purposes. In a preferred embodiment, the frame (and other trim, hinges, etc, described else where in this specification) are made of gold or silver or a gold or silver toned material.

In another embodiment, the pendant of the present invention also comprises a clasp or clasp mechanism for attaching the pendent to a chain or other suitable jewelry item (e.g., bracelet, earrings, etc.). The clasp may be located on the pendant or on the frame.

The pendant of the present invention may also have other features to make it appeal to users. For example, in one embodiment, the pendant or frame of the pendant comprises scroll work at the top and bottom of the pendent. The scroll work may be molded into the pendent plastic of glass or may be part of the frame or both. Additionally, the pendant may be curved (see, e.g., FIG. 1) or have other shapes. The curved shape of the pendant would match the scroll work in that it gives the pendant the appearance of a scroll comprising written material and/or images when the sheet material is inserted into the pendant. Additionally, the pendant may comprise printed or molded trim along the border of the pendant.

The pendant of the present invention is not limited to size. The pendant may be, for example, from about 1 inch to about 3 or more inches in length and/or width.

Other features and advantages of the invention will be apparent from the following description.

### BRIEF DESCRIPTION OF DRAWINGS

FIG. 1 shows a front view of one embodiment of the pendant of the present invention.

FIG. 2 shows a cross sectional view of one embodiment of the present invention.

FIG. 3 shows one embodiment of how sheet materials may be inserted and removed from the pendant of the preset invention.

FIG. 4 shows one embodiment of how the door or cover may be opened to permit the insertion or removal of a sheet material into the pendant of the present invention.

### DETAILED DESCRIPTION OF PREFERRED EMBODIMENTS

The invention will now be described in detail with reference to a few preferred embodiments, as illustrated in accompanying drawings. In the following description, numerous specific details are set forth in order to provide a thorough understanding of the invention. However, it will be apparent to one skilled in the art that the invention may be practiced without some or all of these specific details. In other instances, well-known features and/or process steps have not been described in detail in order to not unnecessarily obscure the invention. The features and advantages of the invention may be better understood with reference to the drawings and discussions that follow.

While the invention has been described with respect to a limited number of embodiments, those skilled in the art, having benefit of this disclosure, will appreciate that other embodiments can be devised which do not depart from the scope of the invention as disclosed herein.

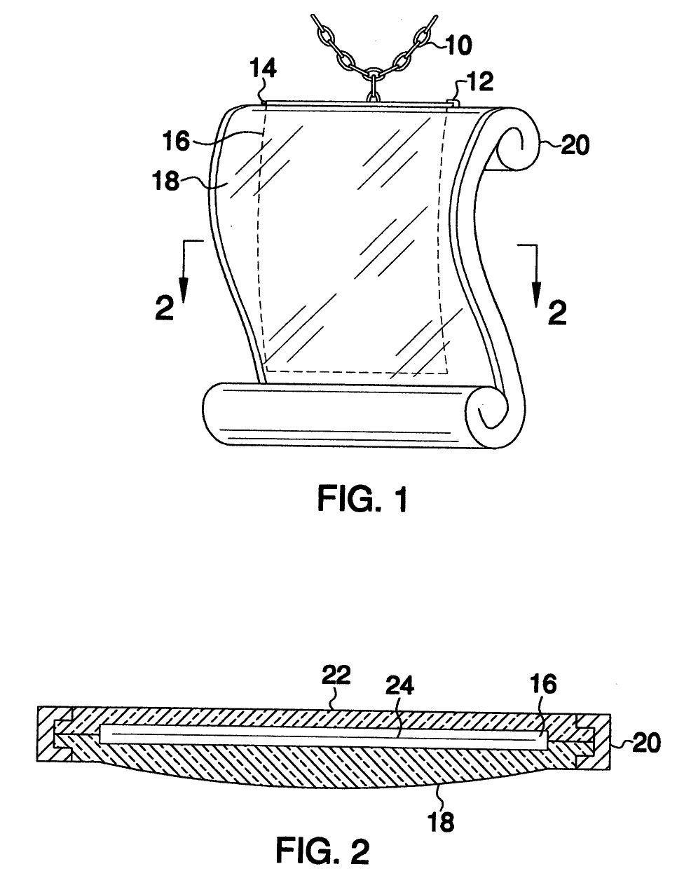

FIG. 1 shows one embodiment of the pendant of the present invention. Shown in this figure are a necklace chain 10 the main unit of the pendant (the pendant) 18, the slot where sheet material can be inserted and removed 16, the frame 20 comprising scroll work and a door or cover comprising a latch 12 and a hinge 14.

FIG. 2 shows one embodiment of a cross section of the pendent of the present invention. Shown are the slot for inserting and removing sheet material 16 the main unit of the pendant 18 showing a convex front side to the front panel of the pendant (suitable for magnifying the text and image in the pendent), the back panel of the pendant 22, the frame 20 and the sheet material 24.

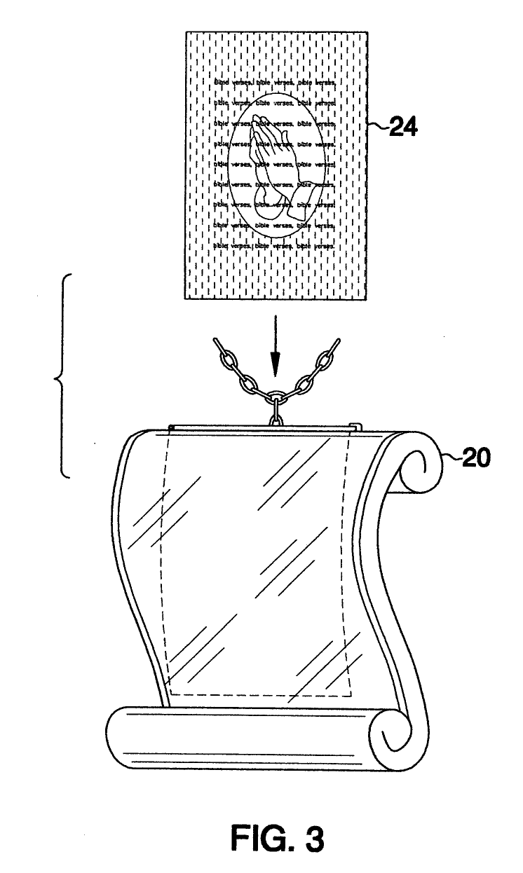

FIG. 3 shows one embodiment of how the sheet material 24 can be inserted and removed from the pendant of the present invention. In another embodiment (not shown) the image is permanently imprinted on the back panel of the locket and the text is imprinted on a clear piece of sheet material. In this way, the text would appear to be suspended in air over the image.

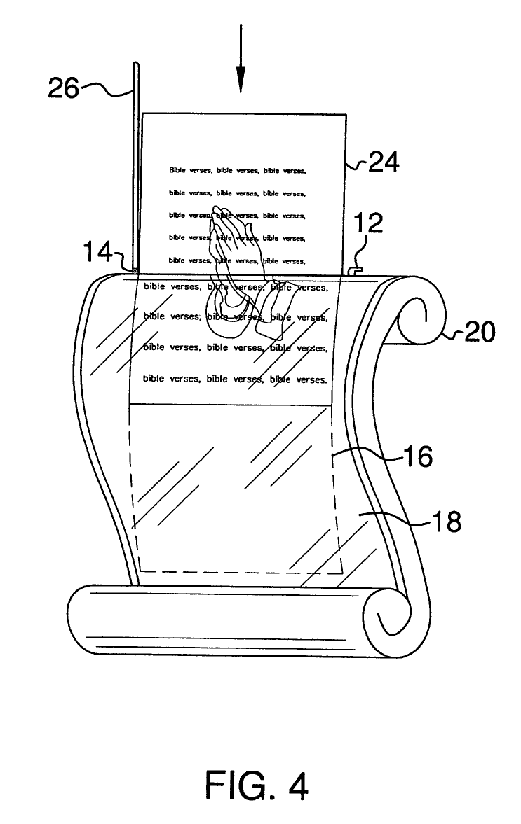

FIG. 4 shows one embodiment of the sheet material being inserted into the pendant of the present invention. The latch 12 and the hinge 14 on the door or cover 26 are shown as are the pendant 18 the slot 16 for holding the sheet material 24 and the frame 20.

What is claimed is:

1. A pendant, comprising: a clear or translucent main unit said main unit comprising i) a slot for inserting and removing a sheet material, ii) a front panel, said front panel comprising a means for magnifying said sheet material inserted into said slot.

2. The pendant of claim 1, wherein said main unit also comprises border trim.

3. The pendant of claim 1, wherein the slot on said main unit also comprises a cover.

4. The pendant of claim 1, wherein said sheet material comprises text wording and/or images.

5. The pendant of claim 1, wherein said sheet material is comprised of paper, plastic or a combination of both.

6. The pendant of claim 1, wherein said main unit additionally comprises designs molded into the top and/or bottom edges.

7. The pendant of claim 6, wherein said moldings are of scroll work.

8. The pendant of claim 1, wherein said means for magnification comprises the shaping of the front panel portion convexly.

9. The pendant of claim 8, wherein said front panel is shaped convexly on both the front side and back side of the front panel.

10. The pendant of claim 1, wherein said means for magnification comprises applying to the front panel a magnifying device.

11. The pendant of claim 1, wherein said pendant additionally comprises a means for attaching a chain.

12. The pendant of claim 1, wherein said pendant also comprises a frame.

13. The pendant of claim 12, wherein said frame additionally comprises designs molded into or printed on the top and/or bottom edges and/or sides.

14. The pendent of claim 1, wherein said pendent comprises a back panel and the back panel is imprinted with an image or picture.

15. The pendent of claim 1, wherein said sheet material comprises a clear material imprinted with text or words.

16. The pendent of claim 1, wherein said means for magnifying said sheet material gives a viewer the impression that said sheet material is suspended in air.

17. A pendant, comprising: a clear or translucent main unit said main unit comprising i) a slot for inserting and removing a sheet material, ii) moldings of scroll work at the top and bottom edges of the main unit, iii) a clear sheet material imprinted with words or text, iii) a cover for the slot said cover comprising a latch and a hinge, iv) a back panel, said back panel comprising an imprinted image, v) a front panel, said front panel comprising a means for magnifying said sheet material inserted into said slot and said image imprinted on said back panel wherein said magnifying means comprises shaping the front side of the front panel convexly, vi) a frame and, vii) a clasp for attaching a chain to said pendant.
